(19) United States
(12) Patent Application Publication
(10) Pub. No.: US 2004/0046383 A1
(43) Pub. Date: Mar. 11, 2004

(54) Method of transmitting printed information, and information carrier

(76) Inventors: Christoph Nagel, Hamburg (DE); Michael Schwertfeger, Hamburg (DE); Arne Koops, Breitenfelde (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/378,425

(22) Filed: Mar. 3, 2003

(30) Foreign Application Priority Data
Mar. 4, 2002 (DE) 102 09 532.9
May 3, 2002 (DE) 102 19 876.4

(51) Int. Cl. B42D 15/00

(52) U.S. Cl. 283/101

(57) ABSTRACT

In order to transmit printed information with security against misuse, the information is provided by means of a flat carrier which is fixed to a substrate by an adhesive and which, because of a lower cohesive force than the adhesive force of the adhesive, is split when pulled off. In this case, the information can be applied to that surface of the carrier which is not provided with the adhesive or can be covered by the carrier stuck on.

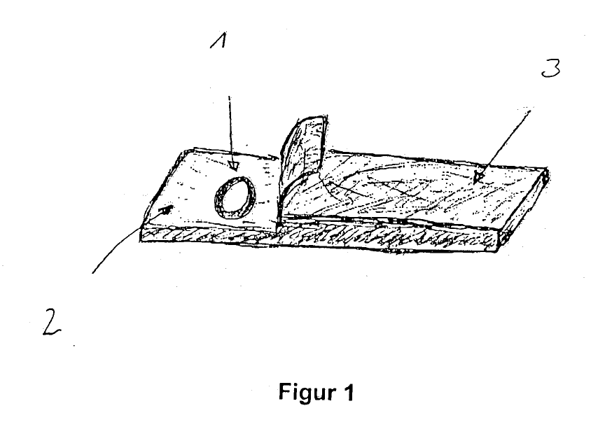

The invention relates to a method of transmitting printed information with security against misuse.

The invention further relates to an information carrier which is protected against misuse.

One example of the transmission of printed information consists in announcing price information by means of a price label on a product, for example in a supermarket. One possible misuse consists in detaching a price label from one product and sticking it onto another product, whose price label has previously likewise been removed or is stuck over. Making this misuse more difficult consists in the price labels being provided with intended tearing points, so that the detachment of the price label is possible only in two or three parts. However, misuse succeeds if there is sufficient time available for the assembly of the label stuck onto the other product again, and sufficient care is applied. The use of more complicated security systems is in opposition to the advertising method, conceived as a mass-production procedure.

Another example of transmitting printed information consists in the sending of PIN numbers for credit cards, access authorizations and the like. In a conspicuous way, PIN numbers of this type are impressed colorlessly in a closed form in the form of a carbonless copy paper set, so that the PIN number can be read only on the inner, strike-through side covered by carbon paper. The receiver of the PIN number can therefore be sure that no third party has gained knowledge of the impressed PIN number if the form set is closed in an undamaged way. Should opening be carried out, the PIN number can immediately by made invalid and replaced by a new, valid PIN number. For this security, in practice the high amount of effort is carried out with the carbonless copy form sets.

The invention is based on the object of permitting the transmission of printed information with adequate security against misuse in a manner which is simple and can be produced easily.

In order to achieve this object, according to the invention a method of the type mentioned at the beginning is characterized in that the information is provided by means of a flat carrier which is fixed to a substrate by an adhesive and which, because of a lower cohesive force than the adhesive force of the adhesive, is split when pulled off.

If the information is applied to that surface of the carrier which is not provided with the adhesive, in order for example to advertise a price, the attempt to pull the carrier off the advertised product leads to the splitting of the carrier according to the invention, so that the surface provided with the price information is then connected to a carrier residue, which has no adhesive action. It is therefore not possible to stick it to another product.

A particularly advantageous embodiment of the idea of the invention is represented by the carrier residue connected to the adhesive being redetachable from the base, in particular in such a way that the base is not damaged in any way. If the product is acquired properly, the carrier residue can be removed without difficulty. For this purpose, it is necessary to set the adhesive force between adhesive and base exactly. Firstly, this must be lower than the force which is required to split the carrier, secondly it must not be so high that the adhesive causes the base to suffer when the carrier residue is removed.

The method according to the invention can also be carried out advantageously when the printed information is covered by the carrier and the carrier and the adhesive are designed to be at least translucent such that, following the splitting of the carrier, the information is legible. In this case, it is possible to print the information, for example a PIN number, simply on one sheet and cover it with the carrier. The covering action must in this case be effected on the upper side of the carrier, for example by coloring the surface, sticking on an opaque material, and so on.

As a result of the splitting of the carrier when it is pulled off, and because of the translucent formation of the carrier and the adhesive, the information, for example the PIN number, becomes legible. Restoring the covering in order to conceal the (unauthorized) acquisition of the PIN number is not possible, since the split carrier material has no adhesive action and, furthermore, because of the irregular splitting, cannot be joined together again with a normal amount of effort in such a way that the fact of the splitting remains unnoticed.

Splittable adhesive systems are known in principle and, for example, are used for the temporary fixing of a paper strip wound onto a roll to the winding lying underneath, in order to avoid unintended unwinding of the paper strip and nevertheless to be able to detach the end easily from the roll as required. The suitability of the use of splittable systems for the quite different field of information transmission addressed here has not been disclosed.

An exemplary embodiment of the invention is illustrated schematically in the appended drawing.

An item of information 1, here in the form of a number, printed on a substrate is covered by a carrier 2 with an opaque surface layer 3. The flat carrier 2 has a lower cohesive force than the adhesive force of the adhesive with which the carrier 2 is stuck to the substrate.

In the event of an attempt to pull the carrier 2 off the substrate, the carrier 2 therefore splits, as a result of which the opaque surface 3 is pulled off with part of the carrier 2.

The carrier 2 and the adhesive underneath are designed to be transparent or at least translucent, so that when the carrier 2 is split, the information 1 covered by the unsplit carrier 2 having the surface layer 3 then becomes visible.

1. A method of transmitting printed information with security against misuse, wherein the information is provided by means of a flat carrier which is fixed to a substrate by an adhesive and which, because of a lower cohesive force than the adhesive force of the adhesive, is split when pulled off.

2. The method as claimed in claim 1, wherein, after the carrier has split, the carrier residue connected to the adhesive can be detached from the base again.

3. The method as claimed in claim 1, wherein the information is applied to that surface of the carrier which is not provided with the adhesive.

4. The method as claimed in claim 1, wherein the information is covered by the carrier, and wherein the carrier and the adhesive are designed to be at least translucent, such that after the carrier has been split the information is legible.

5. An information carrier which is protected against misuse, which comprises a flat carrier which is fixed to a substrate by an adhesive and which, because of a lower cohesive force than the adhesive force of the adhesive, can be split.

6. The information carrier as claimed in claim 5, wherein, after the carrier has been split, the carrier residue connected to the adhesive can be detached from the base again.

7. The information carrier as claimed in claim 5, wherein the information is applied to that surface of the carrier which is not provided with the adhesive.

8. The information carrier as claimed in claim 5, wherein the information is covered by the carrier, and wherein the carrier and the adhesive are designed to be at least translucent in order to enable the legibility of the information following splitting of the carrier.

9. The information carrier as claimed in claim 8, wherein the carrier and the adhesive are translucent.
